(19) United States
(12) Patent Application Publication
(10) Pub. No.: US 2007/0297643 A1
(43) Pub. Date: Dec. 27, 2007

(54) Information processing system, information processing method, and program product therefor

(75) Inventors: Yukiyo Uehori, Tokyo (JP); Tohru Fuse, Tokyo (JP)

Correspondence Address: OLIFF & BERRIDGE, PLC, P.O. BOX 320850, ALEXANDRIA, VA, 22320-4850, US

(73) Assignee: FUJI XEROX CO., LTD., TOKYO (JP)

(21) Appl. No.: 11/580,025

(22) Filed: Oct. 13, 2006

(30) Foreign Application Priority Data
Jun. 23, 2006 (JP) 2006-174632

(51) Int. Cl. G06K 9/00; G06F 3/00

(52) U.S. Cl. 382/100; 715/730

(57) ABSTRACT

An information processing system includes an extracting portion that extracts characteristic information of at least one of a presenter and a participant while the presenter is delivering a presentation with the use of a material, on the basis of information on at least one of the presenter and the participant captured, a determining portion that determines an importance level of the material on the basis of the characteristic information extracted by the extracting portion, and a processing portion that processes data of the material on the basis of the importance level determined by the determining portion.

### BACKGROUND

1. Technical Field

This invention relates to an information processing system, an information processing method, and a program product therefor.

2. Related Art

In general, a conference, a presentation or the like is progressed by a presenter delivering a presentation to participants while using multiple materials, slides and the like. Persons who have not been able to participate in the conference or the like or the persons who have participated in the conference and like to look back on the conference later can look back on the content of the conference or the like by viewing delivered conference slides and delivered electronic data of the conference slides.

### SUMMARY

An aspect of the present invention provides an information processing system including: an extracting portion that extracts characteristic information of at least one of a presenter and a participant while the presenter is delivering a presentation with the use of a material, on the basis of information on at least one of the presenter and the participant captured; a determining portion that determines an importance level of the material on the basis of the characteristic information extracted by the extracting portion; and a processing portion that processes data of the material on the basis of the importance level determined by the determining portion.

### BRIEF DESCRIPTION OF THE DRAWINGS

Embodiments of the present invention will be described in detail based on the following figures, wherein:

FIG. 1 is an overall structural view of a system in accordance with an exemplary embodiment of the invention;

FIG. 2 is a view showing a structure of a delivery system;

FIG. 3 is a view showing an example of a summary creation table corresponding to slide classification;

FIG. 4 is a flowchart showing a procedure of creating a stained glass like summary image by using the table shown in FIG. 3;

FIG. 5 is a view showing an example of a summary creation table corresponding to a slide description time;

FIG. 6 is a flowchart showing a procedure of creating a stained glass like summary image by using the summary creation table shown in FIG. 5;

FIG. 7A is a view showing slides with a determined importance level;

FIG. 7B is a view showing a stained glass like summary image;

FIG. 8 is a flowchart of generating a summary image;

FIG. 9 is a view showing an example of a summary reflecting an attention point in a conference;

FIG. 10 is a flowchart showing a procedure of creating the summary image of FIG. 9;

FIG. 11 is a view explaining an example in which a summary based on the content is applied to a search result;

FIG. 12 is a flowchart showing a procedure of creating the summary image of FIG. 11;

FIG. 13A is a view showing slides with a determined classification;

FIG. 13B is a view showing a stained glass summary image;

FIG. 14 is a view showing a table for setting the maximum number of the slides composed when a stained glass based on slide classification is created;

FIG. 15 is a view showing an example of a case where a newspaper summary is displayed by means of a stained glass like summary image;

FIG. 16A and FIG. 16B are views showing an example of a case where a cartoon summary image is created with the slide images;

FIG. 17A through FIG. 17D are views showing an example of a case where a cartoon summary is created with a slide and images of a presenter and a participant;

FIG. 18A through FIG. 18C are views showing an example of a summary using a video collage template; and

FIG. 19 is a view showing a hardware configuration of an information recording and delivering apparatus.

### DETAILED DESCRIPTION

A description will now be given, with reference to the accompanying drawings, of embodiments of the present invention.

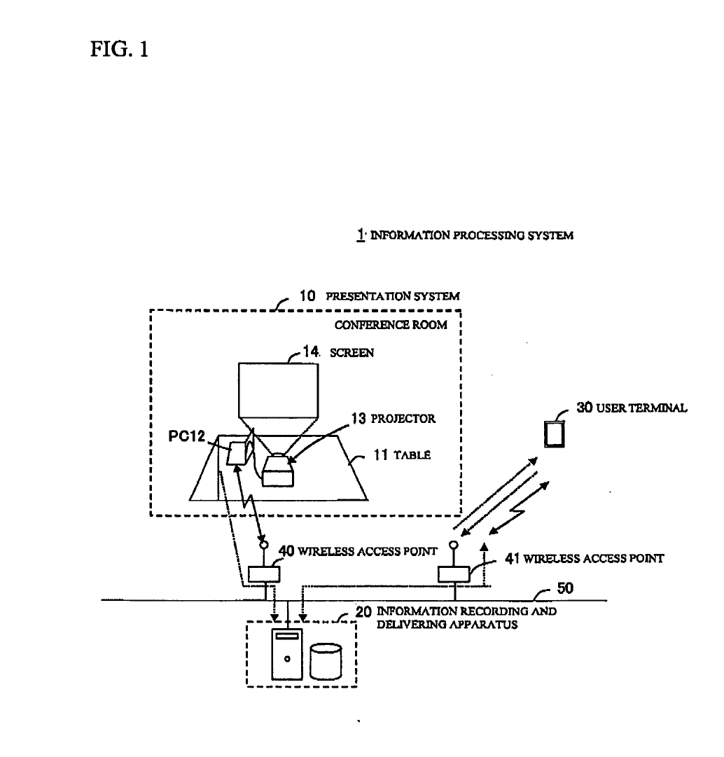

A description will now be given of exemplary embodiments employed in the present invention. FIG. 1 is an overall structural view of an information processing system in accordance with an aspect of the invention. An information processing system 1 includes: a presentation system 10; an information recording and delivering apparatus 20, a user terminal 30; and the like. The presentation system 10 is provided with a Personal Computer (PC) 12 set on a table 11 of a conference room, a projector 13, and a screen 14. The presentation system 10 and the user terminal 30 are connected to a network 50 through wireless access points 40 and 41. The network 50 is composed of a non-public line network or a corporate LAN. The network 50 may be composed of a fixed line, a wireless line, or a communication line composed of both the fixed line and the wireless line. The presentation system 10 and the user terminal 30 may be connected to the network 50 by way of the fixed line connection.

The presentation system 10 is provided with a video camera and a microphone. The presentation system 10 captures a presenter and one or more participants, the presenter delivering a presentation to participants by using multiple materials or documents, and sends conference data including capture data to the information recording and delivering apparatus 20. Here, capture data is the data obtained by capturing the presenter and the participants by the video camera. Further, the captured data is also the data obtained by capturing sound from the presenter and the participants by the microphone. The captured data is sent to the information recording and delivering apparatus 20 via the PC 12. Here, an example is shown in such a manner that the presenter delivers the presentation to multiple participants while using multiple slides (materials) in a conference. Also, a slide data file is composed of multiple pages of slide elements. While only one presentation system 10 is shown in the figure, each presentation system 10 is set respectively in multiple conference rooms, if there are the multiple conference rooms.

The presenter operates the PC 12 and projects data of PowerPoint as a material by the projector 13. The data of PowerPoint is sent to the information recording and delivering apparatus 20 via the PC 12. The information recording and delivering apparatus 20 can acquire the material data. The slides projected by the projector 13 may be captured by a video camera, and data obtained by capturing the slides may be accumulated as material data in the information recording and delivering apparatus 20.

The information recording and delivering apparatus 20 accumulates conference data sent from the presentation system 10, and delivers data obtained by processing the accumulated conference data to the user terminal 30. The user terminal 30 has a function of receiving delivery data sent from the information recording and delivering apparatus 20 and displaying the delivery data. The user terminal 30 is composed of a portable terminal such as a notebook computer and a mobile telephone. FIG. 1 shows a case where data is sent and received between only one user terminal and the information recording and delivering apparatus 20. However, in reality, data can be sent and received between multiple user terminals and the information recording and delivering apparatus 20.

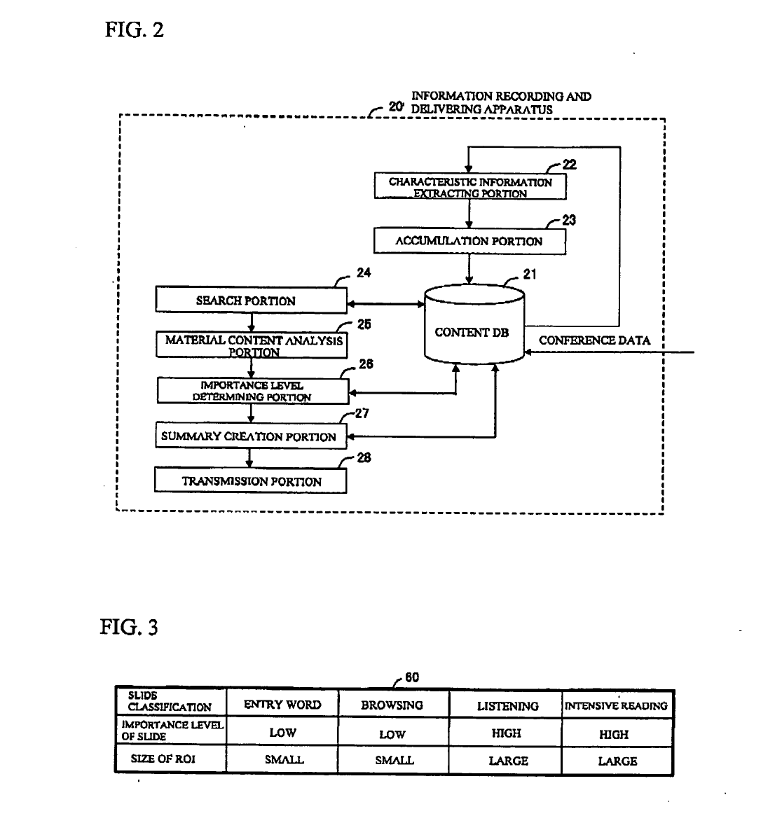

FIG. 2 shows a structure of the information recording and delivering apparatus 20. As shown in FIG. 2, the information recording and delivering apparatus 20 is provided with a content DB 21, a characteristic information extracting portion 22 serving as an extracting portion, an accumulation portion 23, a search portion 24, a material content analysis portion 25 serving as an analysis portion, an importance level determining portion 26 serving as a determining portion, a summary creation portion 27 serving as a processing portion, and a transmission portion 28. The content DB 21 stores the content data captured by the presentation system 10 and characteristic information of the presenter and participants.

The characteristic information extracting portion 22 extracts characteristic information of the presenter or participants when the presenter delivers the slides based on the conference data obtained by capturing the presenter or the participants. In addition, the characteristic information extracting portion 22 utilizes an image processing technique, a sound recognition technique or the like, when extracting the above-described characteristic information. Here, the characteristic information extracting portion 22 extracts information on an intention of the presenter as characteristic information of the presenter. The characteristic information extracting portion 22 accomplishes a function by executing a given program on a computer. For example, the characteristic information extracting portion 22 extracts the characteristic information such as a slide presentation time of the presenter, an attribute of the presenter, the number of the presenters, the number of the descriptions of the slide of the presenter, a keyword mentioned by the presenter, a region of interest in the slide pointed by the presenter as the information on the intention of the presenter.

The characteristic information extracting portion 22 can determine the presentation time of the slide of the presenter by implementing sound signal processing on the data produced by the presenter presenting the slide. In addition, the characteristic information extracting portion 22 can determine an attribute of the presenter by referring to the data of the job title written in a predetermined presenters list. The characteristic information extracting portion 22 recognizes sound produced by the presenter by sound signal processing, detects that, for example, the same key word and the same sentence are repeatedly described by utilizing the results of the sound recognition, and thereby determines the number of descriptions of the slide of the presenter. The characteristic information extracting portion 22 determines a position in the slide pointed by the presenter by using the image processing technique, and thereby determines the region of interest in the slide pointed by the presenter.

For example, when presentation time of the slide is long, it is possible to understand that the slide is important as an intention of the presenter. By contrast, when the presentation time of the slide is short, it is possible to understand that the slide is not important as an intention of the presenter. In addition, when the attribute of a presenter is, for example, a corporate executive or the like, it is possible to understand that the slide is important as an intention of the presenter. Further, when the number of presenters is large, it is possible to understand that the slide is important as an intention of the presenter.

The characteristic information extracting portion 22 extracts the information on reactions of the participants as characteristic information of the participants. For example, the characteristic information extracting portion 22 extracts the number of references to the slide of the participant or an viewing rate of the slide of the participant as the characteristic information of the participant. For example, the characteristic information extracting portion 22 detects a direction of a sight line of the participant by using the image processing technique, and can determine the number of references to the slide of the participant. Also, the characteristic information extracting portion 22 divides reference time of the slide of the participant by the description time of the slide of the presenter, and can obtain the viewing rate of the slide of the participant. When the number of references to the slide of the participant is large, it is possible to learn that the participant is interested in the slide. Meanwhile, when the number of references of the slide of the participant is small, it is possible to learn that the participant is not interested in the slide. In addition, the characteristic information extracting portion 22 may extract, based on the conference data obtained by capturing the presenter or participants, a slide projection start time, a slide projection finish time, a text character string included in the slide, word appearance coordinates, the pointed number of characters, a speech segment and the like as the characteristic information. For example, it is possible to convey the intention of the slide creator with respect to the slide by means of the pointed number of characters.

The position of the region of interest in the slide pointed by the presenter is determined by a pointer position pointed by the presenter during the conference in relation to the position of the slide. Here, a description is given of an example in which the characteristic information extracting portion 22 automatically extracts the characteristic information from the conference data stored in the content DB 21. However, a user may input characteristic information onto the content DB 21 by using an input interface such as a keyboard and a mouse. The accumulation portion 23 stores the characteristic information extracted by the characteristic information extracting portion 22 in the content DB 21 in association with the conference data.

The search portion 24 searches for the conference content data stored in the content DB 21. The search portion 24 produces a search formula from a search inquiry given from the user terminal 30, executes the inquiry to the content DB 21 based on the search formula, and obtains the search result. Here, the search inquiry is given in the form of a keyword, a document, sound, an image, a combination thereof, or the like. The material content analysis portion 25 analyzes the content of the slide based on the keyword, sound, or the image included in the slide data by using the image processing technique or the sound recognition technique.

The importance level determining portion 26 determines the importance level of each slide based on characteristic information extracted by the characteristic information extracting portion 22 and the slide content analyzed by the material content analysis portion 25. Also, when the slide content is not analyzed by the material content analysis portion 25, the importance level determining portion 26 can determine the importance level of each slide based on only the characteristic information extracted by the characteristic information extracting portion 22. The importance level determining portion 26 stores such determined importance level of each slide in the content DB 21 in association with conference data.

The summary creation portion 27 processes multiple pieces of the slide data based on the importance level of each slide determined by the importance level determining portion 26. Specifically, the summary creation portion 27 creates data obtained by composing multiple slides based on the importance level of each slide. For example, the summary creation portion 27 creates data obtained by composing multiple slides based on the importance level of each slide. At this time, the summary creation portion 27 creates a composition by changing the regions on which the slides are placed in accordance with the importance levels of the slides. The summary creation portion 27 creates a stained glass like summary image when producing a summary.

Specifically, the summary creation portion 27 automatically extracts a Region of Interest (hereinafter, referred to as ROI) by using the characteristics of the slide image obtained by the search result of the search portion 24. A method of extracting ROI is described as follows. The summary creation portion 27 extracts a rectangle including a region with a high density in the slide image as ROI. Then, the summary creation portion 27 automatically extracts ROI by performing an image processing calculation such as changing the area of ROI utilizing an importance level corresponding to slide image data. This can extract ROI reflecting the slide content. Next, the summary creation portion 27 composes a stained glass like image by arranging each ROI respectively extracted from multiple slide images to produce an image. Here, the size of the composed image, the number of slides used, and the layout may be changed in accordance with a screen size of a display portion of the user terminal 30. The transmission portion 28 sends the summary data created by the summary creation portion 27 to the user terminal 30. The display portion of the user terminal 30 displays the composed stained glass like summary image as a result for a user.

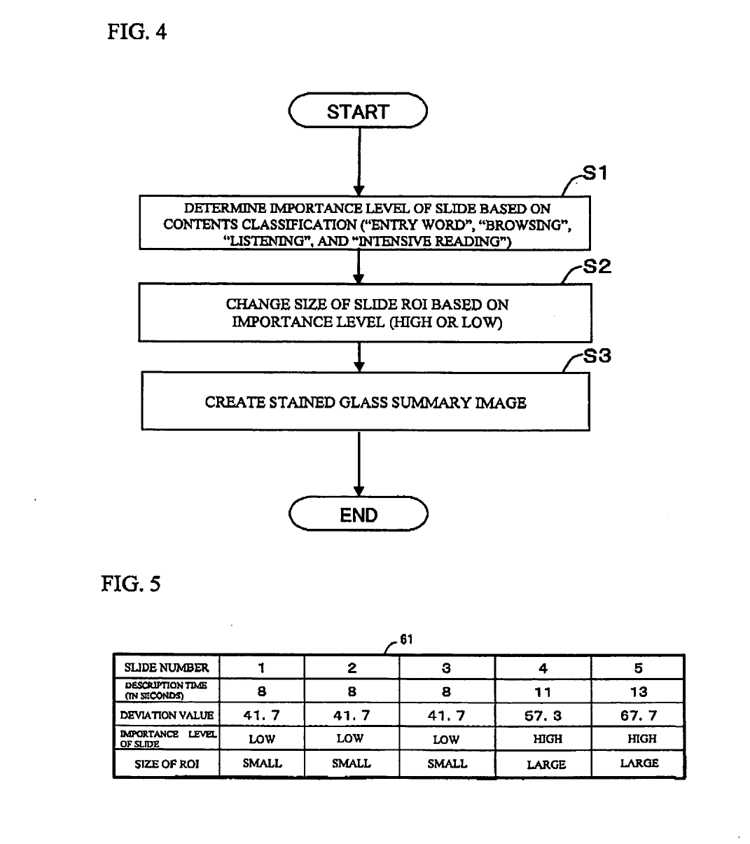

FIG. 3 is a view showing an example of a summary creation table corresponding to slide classification. FIG. 4 is a flowchart showing a procedure of creating a stained glass like summary image by using the table shown in FIG. 3. A summary creation table 60 shown in FIG. 3 is stored in the content DB 21. The material content analysis portion 25 analyzes the content of the slide based on the keyword, sound, or image included in the slide data, and classifies the slide into “headline”, “browsing”, “listening”, or “intensive reading” in accordance with the analysis result.

The importance level determining portion 26 refers to the summary creation table 60 stored in the content DB 21, and determines the importance level of the slide based on the slide classification composed of “headline”, “browsing”, “listening”, and “intensive reading” (step S1). In the example shown in FIG. 3, the importance level determining portion 26 determines an importance level of the slide to be classified into “headline” as “low”, the importance level of the slide classified into “browsing” as “low”, the importance level of the slide classified into “listening” as “high”, and the importance level of the slide classified into “intensive reading” as “high”. Here, “low” represents that the importance level of the slide is low, and “high” represents that the importance level of the slide is high.

The summary creation portion 27 determines the size of ROI of the slide image in accordance with the importance level (high or low) of the slide (step S2). The summary creation portion 27 determines the size of ROI as “small” for the slide having the importance level of “low”, and determines the size of ROI as “large” for the slide having the importance level of “high”. The summary creation portion 27 creates the stained glass like summary image in accordance with the determined size of ROI (step S3).

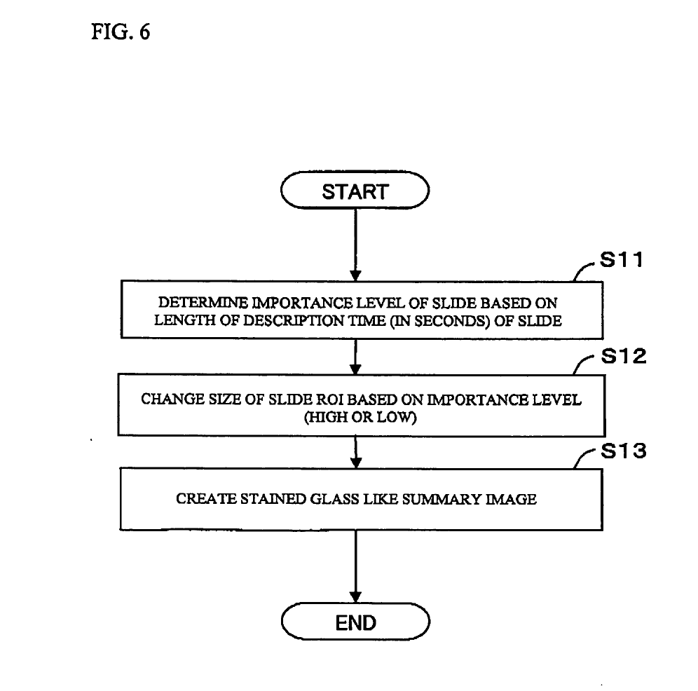

FIG. 5 is a view showing an example of a summary creation table corresponding to the description time of the slide. FIG. 6 is a flowchart showing a procedure of creating the stained glass like summary image by using the summary creation table shown in FIG. 5. A summary creation table 61 shown in FIG. 5 is stored in the content DB 21. The importance level determining portion 26 determines an importance level of a slide image based on a length of description time (in seconds) of the slide (step S11). Specifically, the importance level determining portion 26 calculates a deviation value of each slide from whole description time and the description time of each slide. Next, the importance level determining portion 26 determines the importance level of the slide from the deviation value of each slide with reference to a threshold. Here, the importance level determining portion 26 determines the importance level of the slide having the deviation value of 50 or less as “small”, and the importance level of the slide having a deviation value of 50 or more as “large”.

The summary creation portion 27 determines a size of ROT of the slide image by the importance level (high or low) of the slide (step S12). Here, the summary creation portion 27 determines the size of ROI as “small” for the slide having the importance level of “low”, and determines the size of ROI as “large” for the slide having the importance level of “high”. The summary creation portion 27 creates the stained glass like summary image based on the determined size of ROI (step S13).

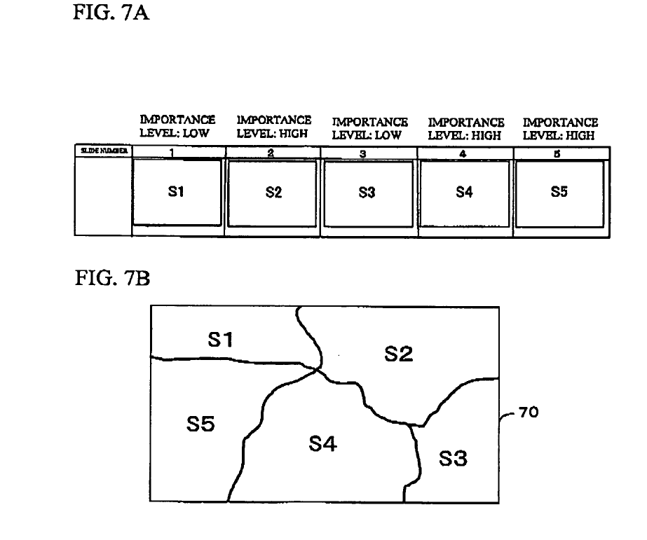

FIG. 7A is a view showing slides having such determined importance level. FIG. 7B is a view showing the stained glass like summary image. As shown in FIG. 7B, the summary creation portion 27 determines the size of ROI of the slide image based on the importance level (high or low) of the slide. The summary creation portion 27 determines the sizes of ROIs as “small” with respect to slides S1 and S3 having the importance level of “low”, and determines the sizes of ROIs as “large” with respect to slides S2, S4, and S5 having the importance level of “high”. The summary creation portion 27 creates the stained glass like summary image based on the determined sizes of the ROIs. As shown in FIG. 7B, the importance levels of the slide S1 and S3 are low, and a small region is allocated to the slides S1 and S3. Meanwhile, the importance levels of the slides S2, S4, and S5 are high, and wide regions are allocated to the slides S2, S4, and S5.

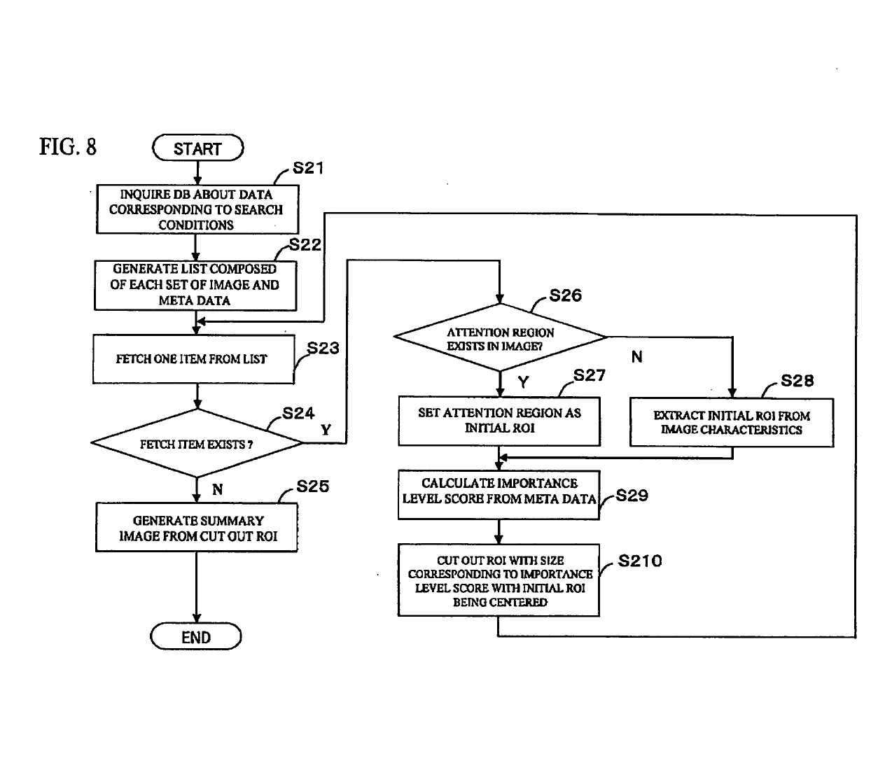

FIG. 8 is a flowchart of creating the summary image. The search portion 24 inquires the content DB 21 about data corresponding with search conditions (step S21). The search portion 24 generates a list composed of each set of an image and index data (step S22). The search portion 24 fetches one item from the list (step S23).

If there is a fetch item (“Y” at step S24), the summary creation portion 27 determines whether or not there is a region of interest in an image. If there is the region of interest in the image (“Y” at step S26), the summary creation portion 27 sets the region of interest as initial ROI (step S27). When there is no region of interest in the image (“N” at step S26), the summary creation portion 27 extracts the initial ROI from characteristics of the image (step S28). The importance level determining portion 26 calculates an importance level score from index data (step S29). The summary creation portion 27 cuts out ROI with the size corresponding to the importance level score centering on the initial ROI (step S210), and the procedure goes back to step S23. If there is no fetch item (“N” at step 824), the summary creation portion 27 creates the summary image from such cut out ROI (step S25).

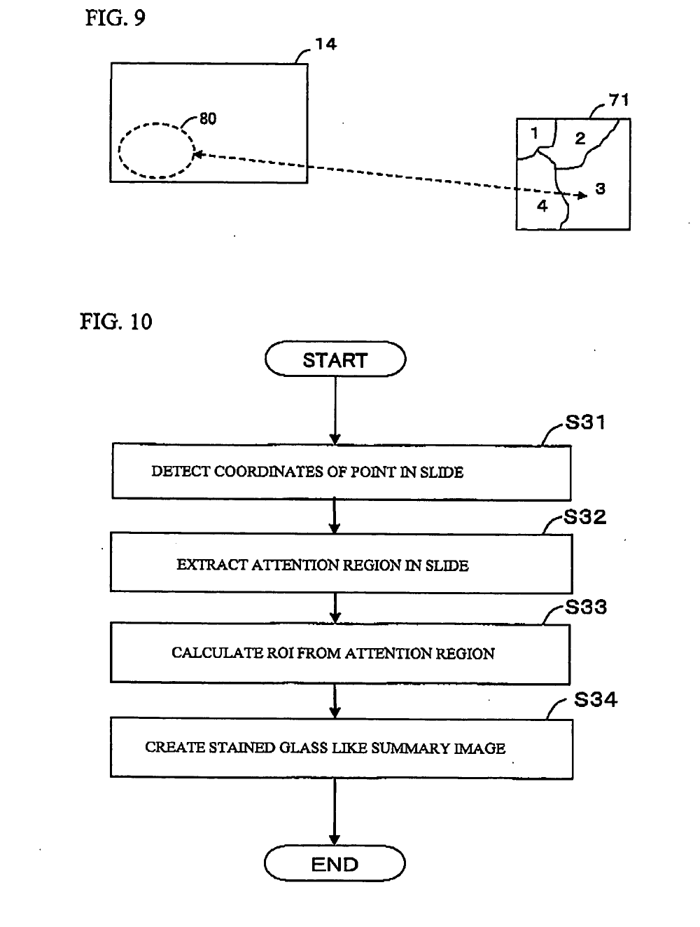

FIG. 9 is a view showing an example of a summary reflecting the attention point in the conference. FIG. 10 is a flowchart showing a procedure of creating the summary image of FIG. 9. In FIG. 9, referential symbol 80 represents an attention region pointed by the conference presenter on the screen 14. The characteristic information extracting portion 22 extracts coordinates of a point in the slide pointed by an electronic pointer of the presenter in the conference based on the conference data (step S31). The characteristic information extracting portion 22 coordinates the slide with the point coordinates, and extracts the attention region in the slide (step S32). When the summary creation portion 27 creates a stained glass like summary image, the summary creation portion 27 calculates ROI from the attention region (step S33). The summary creation portion 27 creates the stained glass like summary image by using such calculated ROI (step S34).

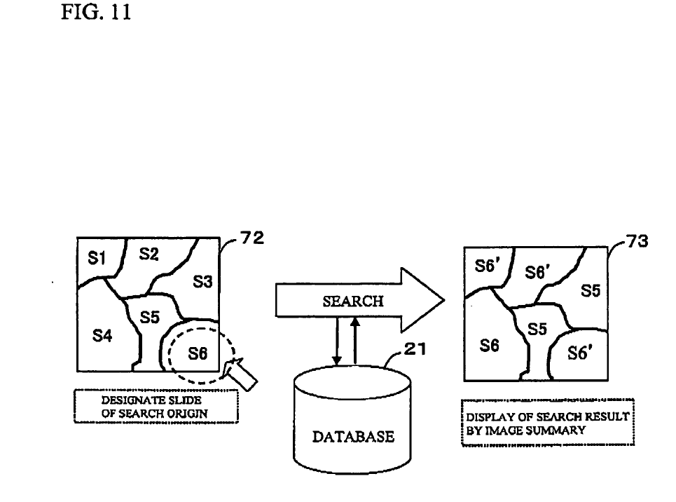

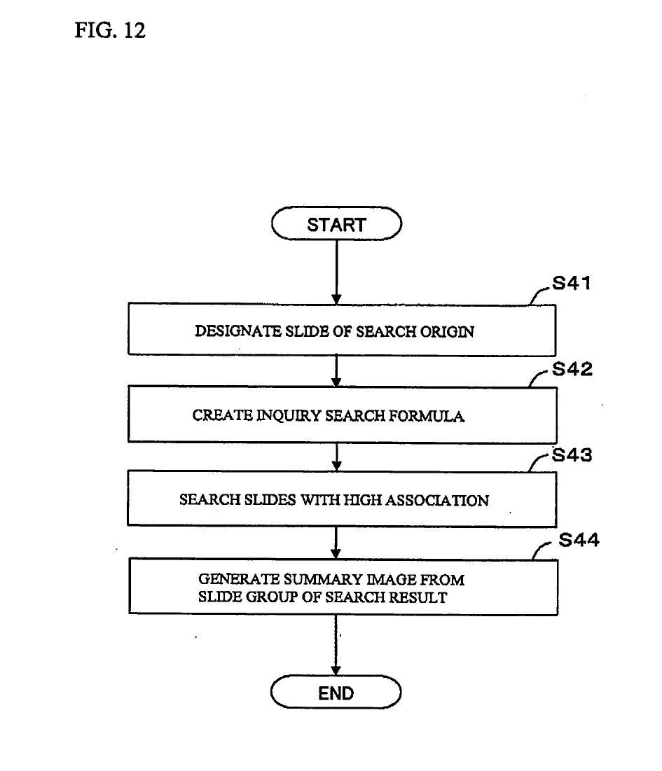

FIG. 11 is a view explaining an example in which a summary according to the content is applied to the search result. FIG. 12 is a flowchart showing a procedure of creating a summary image of FIG. 11. When a slide S6 to be a search origin is designated from an image summary screen 72 displayed on the display portion of the user terminal 30 (step S41), the search portion 24 extracts the information such as a keyword, text, sound, and image included in such designated slide data from the content DB 21, and creates an inquiry search formula (step S42). The search portion 24 inquires the content DB 21, and obtains slides having high association levels as search results (step S43). The summary creation portion 27 generates a stained glass like summary image 73 from a slide group of the search results (step S44).

At this time, the summary creation portion 27 reflects the importance level (high or low) of each slide to the size (large or small) of ROI. This allows the user to obtain the search results of the slides related to the slide designated at step S41. FIG. 11 shows an example in which a summary image is generated in descending order with respect to the association levels such as slide S6>slide S6′>slide S6″>slide S5. Therefore, in the stained glass like summary image 73, the region of the slide S6 having the highest association level becomes large, and the region of the slide S5 having the lowest association level becomes small.

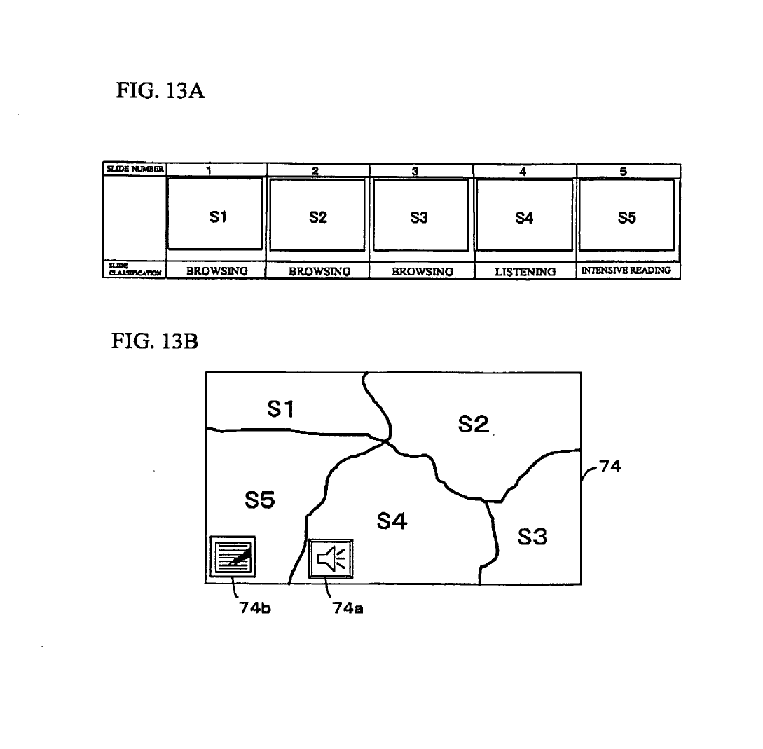

FIG. 13A is a view showing the slides having determined classifications, and FIG. 13B is a view showing a stained glass like summary image. The material content analysis portion 25 analyzes the content of a slide based on a keyword, sound, or image included in the slide data, and classifies the slide into “headline”, “browsing”, “listening”, or “intensive reading” in accordance with the analysis results. In the example shown in FIG. 13A, the material content analysis portion 25 classifies the slides S1 through S3 into “browsing”, the slide S4 into “listening”, and the slide S5 into “intensive reading”. In addition, as shown in FIG. 13B, the summary creation portion 27 additionally displays icons in accordance with the classifications of the slides. Here, the summary creation portion 27 adds an icon 74a of “listening” in a region of the slide S4 classified into “listening”, and adds an icon 74b of “intensive reading” in a region of the slide S5 classified into “intensive reading” in a stained glass like summary image 74 to create a summary.

In this manner, when a user views the stained glass like summary image 74 and the icon 74a of “listening” is displayed, the user clicks the icon of “listening” with a mouse, so that the user can comprehend and listen to the content of the slide by reproducing the sound captured while the slide is being presented. Also, when a user view the stained glass like summary image 74 and the icon 74b of “intensive reading” is displayed, the user clicks the icon of “intensive reading” with a mouse, so that the user can comprehend the content of the slide S5 and intensively read sentences included in the slide S5 by magnifying the slide.

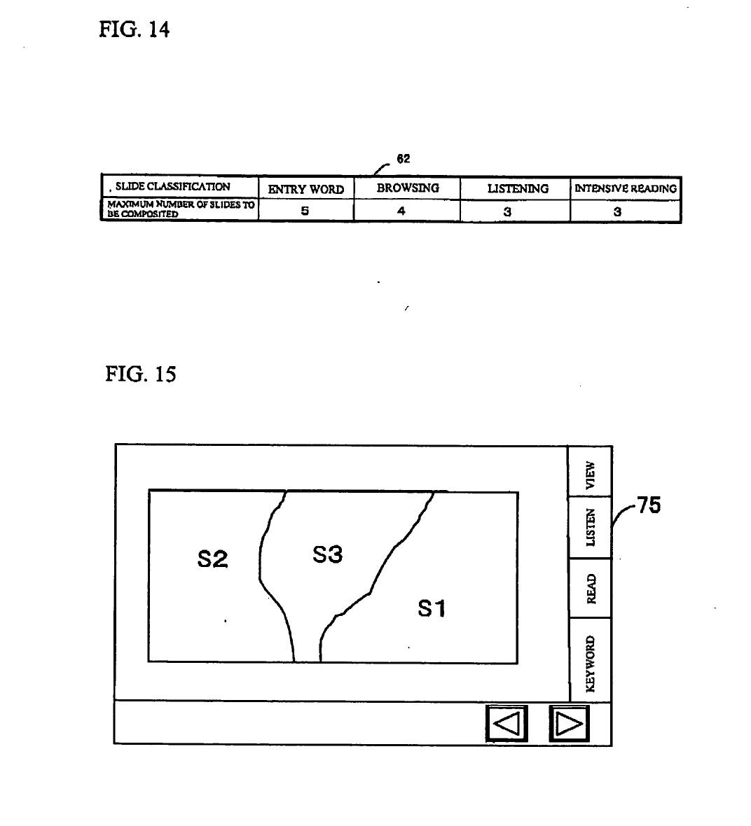

Next, a description will be given of an example of a case where a stained glass like summary reflecting the importance level based on slide classification is applied to a newspaper summary. FIG. 14 is a view showing a table for setting the maximum number of the slides to be composed when the stained glass is produced based on the slide classification. FIG. 15 is a view showing an example of a case where a newspaper summary 75 is displayed with a stained glass like summary image. A table 62 for setting the maximum number of the slides shown in FIG. 14 is stored in the content DB 21 in advance. The newspaper summary represents news regularly delivered over the Internet or the like. The newspaper summary has been conventionally received by users in the form of a thumbnail.

The material content analysis portion 25 analyzes the content of the slide on the basis of the keyword, sound, or image included in the slide data, and classifies the slide into “headline”, “browsing”, “listening”, or “intensive reading” in accordance with the analysis results. The summary creation portion 27 refers to the table for setting the maximum number of the slides 62. With respect to the slides classified into “headline”, the summary creation portion 27 includes 5 slides at the maximum in the stained glass summary image since it is easily understand the contents thereof. With respect to the slides classified into “browsing”, the summary creation portion 27 includes four slides at the maximum in the stained glass like summary image since it is slightly difficult to comprehend the content. With respect to the slides classified into “listening” or “intensive reading”, the summary creation portion 27 includes three slides at the maximum in the stained glass like summary image since it is difficult to comprehend the content. The newspaper summary 75 is thus created. In FIG. 15, the slides classified into “listening” or “intensive reading” are processed. Therefore, the three slides S1 to S3 are embedded in the stained glass like summary image. The transmission portion 28 sends the newspaper summary created by the summary creation portion 27 to the user terminal 30. The user terminal 30 offers the newspaper summary 75 shown in FIG. 15 to the users. This allows the users to learn the news at a glance in accordance with the content classification.

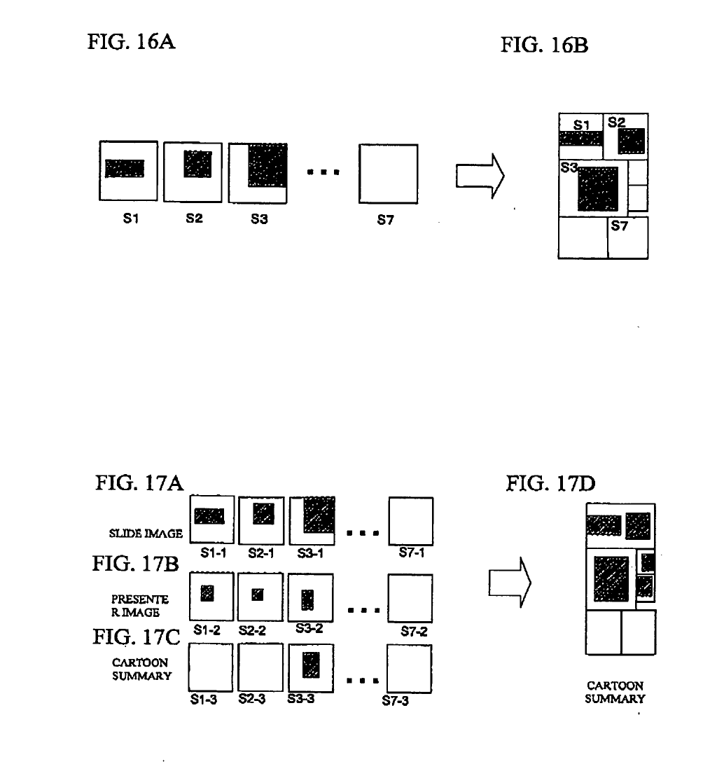

FIG. 16A and FIG. 16B are views showing an example of creating a cartoon summary image from slide images S1 to S7. The summary creation portion 27 extracts ROI by utilizing the slide classification or the annotation region. In FIG. 16A, a region with hatching indicates a location extracted by the summary creation portion 27 as ROI. The summary creation portion 27 regards a slide change point as a shot change point, performs segmentation, and packs the slide images in the form of a cartoon summary with ROI of each slide being centered. This allows the user to view a summary image with ROI of the slide image being centered via the user terminal 30.

FIG. 17A through FIG. 17D are views showing an example of creating a cartoon summary from the slides and images of a presenter and a participant. FIG. 17A shows slide images S1-1 through S7-1. FIG. 17B shows images S1-2 through S7-2 obtained by capturing the presenter when the presenter delivers the respective slides S1-1 through S7-1. FIG. 17C shows images S1-3 through S7-3 obtained by capturing the participant when the presenter delivers the respective slides S1-1 through S7-1. FIG. 17D shows the cartoon summary. When there is video data of the presenter and the participant, the search portion 24 selects an appropriate representative frame image on the basis of whether or not there is the speech, movement or the like. Then, the importance level determining portion 26 calculates the importance level score of the images of the presenter and the participant based on meta data on the basis of whether or not there is the speech and whether the speech time is long or short. The importance level determining portion 26 calculates the importance level score by changing the weight based on the image category, so that the slides can be used principally and the images of persons can be used secondarily.

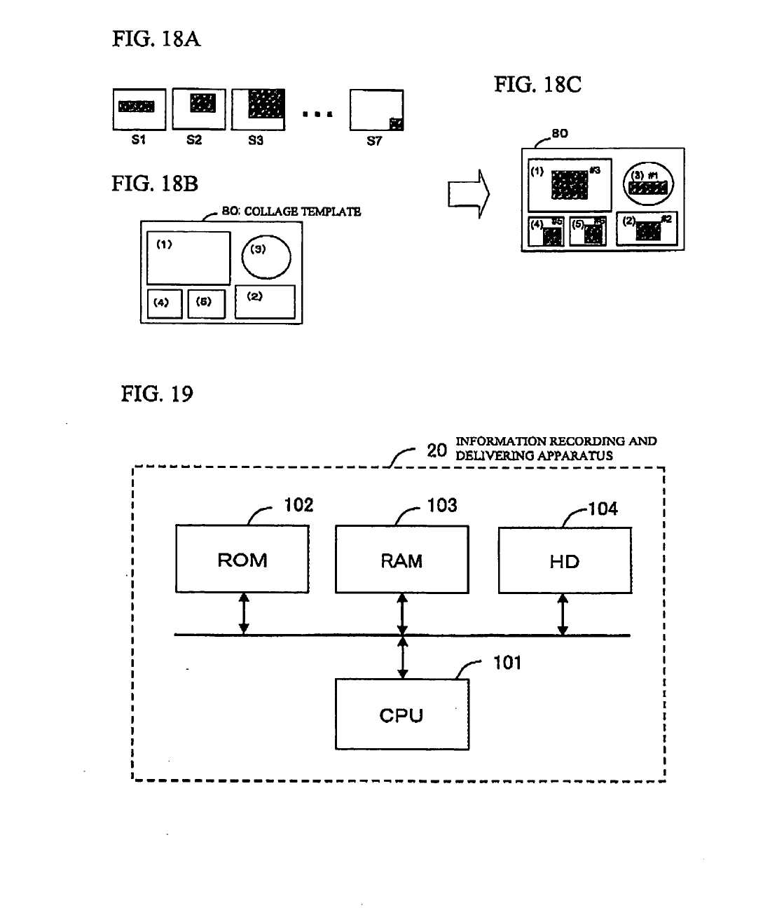

FIG. 18A through FIG. 18C are views showing an example of a summary using a video collage template. FIG. 18A shows the slide images S1 to S7 and the extracted ROIs. FIG. 18B shows the collage template and collage region priority. FIG. 18C shows an example in which a summary using the collage template is composed with ROIs of the slide images being centered. In the figures, hatching represents ROI. With respect to respective cut out collage regions (1) through (5) of a collage template 80, assigned priority orders are predetermined on the basis of the sizes and layouts. Higher priority collage regions are allocated for the slide images S1 through S5 in descending order of the importance level scores of the images calculated by the importance level determining portion 26.

FIG. 19 is a view showing a hardware configuration of the information recording and delivering apparatus. As shown in FIG. 19, the information recording and delivering apparatus 20 is composed of a Central Processing Unit (CPU) 101, a Read only Memory (ROM) 102, a Random Access Memory (RAM) 103, a Hard Disk (HD) 104, and the like. The CPU 101 executes a program stored in the ROM 102 or in the HD 104 by using the RAM 103 as a working memory, and thereby each function shown in FIG. 2 is accomplished. An information processing method in accordance with an aspect of the invention is performed by the information processing system 1.

In accordance with the above-described exemplary embodiment, ROI, namely, an attention region is extracted by utilizing meta data other than image characteristics such as an intention of a presenter, a reaction of a participant, a presentation content, and a feedback from the participant in a conference. This enables extraction based on the content. It is therefore possible to produce a summary reflecting intentions of the presenter and the participants and the importance level of the participants. Further, by composing the stained glass like summary image with such extracted ROIs, the user can easily understand a conference point, shorten the time for comprehending the content of a whole conference, and easily find a region for which the user searches. For a person who looks back on a material later, the intention of the presenter and the reactions of the participants can be conveyed so as to support the person who looks back on the material.

While the exemplary embodiment of the invention has been described in detail, the invention is not limited to the above-described exemplary embodiment, and various variations and modifications may be made without departing from the scope of the invention described in the claims. In the foregoing exemplary embodiment, as an example of a material, the electronic material such as a slide image has been illustratively described. However, the invention is not limited thereto, and can be applied to a paper material delivered in a conference. Further, in the foregoing exemplary embodiment, the example of creating a summary based on index data has been described. However, the invention is not limited thereto, and the invention can be also applied to a method of creating a material such as a method of processing multiple materials. In addition to processing the materials, processing such as sorting out slide images may be performed on the basis of the index data.

In addition, as described heretofore, the description has been given of the example of the case where when slides serving as a material include multiple elements, the importance level determining portion 26 determines the importance level for each of multiple elements, and the summary creation portion 27 processes data of the elements on the basis of the importance levels of the elements determined by the importance level determining portion 26. The invention is not limited thereto, and the invention can be applied to a case where the material does not include multiple elements. In addition to the case of creating a summary by composing the materials as described above, for example, the transmission portion 28 may deliver material data on the basis of the importance level of the material determined by the importance level determining portion 26. Then, the importance level of the material can be changed in accordance with the user who browses the data. For example, it is possible to set importance priority in advance in the order of “headline”, “browsing”, “listening”, and “intensive reading” for a user. In the afore-mentioned case, the transmission portion 28 transmits the material data to the user in accordance with the setting of the user.

Furthermore, the transmission portion 28 may select the material to be processed based on the classification results of the slide elements. For example, when a user sets that slides of “headline” and “browsing” are sent and the slide of “listening” or “intensive reading” is not sent, the transmission portion 28 selects the slide elements to be delivered on the basis of the above-described settings and the classification results of the slide elements. This allows the user to obtain a desired material. Also, the transmission portion 28 may decide a weight level in consideration of the interest of who is to receive the delivery. For example, in the case where it is just enough to know the outline, the importance level determining portion 26 sets the importance level of “intensive reading” classification to low, so that an importance level of “headline” classification becomes high By changing the importance levels classified by the importance level determining portion 26 as described above, the transmission portion 28 is capable of appropriately delivering a material to the user.

An information processing method employed as an aspect of the present invention is realized with a CPU, ROM, RAM, and the like, by installing a program from a portable memory device or a storage device such as an HD device, CD-ROM, DVD, or a flexible disc or downloading the program through a communications line. Then the steps of program are executed as CPU operates the program.

The foregoing-description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
an extracting portion that extracts characteristic information of at least one of a presenter and a participant while the presenter is delivering a presentation to the participant with the use of a material, on the basis of information on at least one of the presenter and the participant captured;
a determining portion that determines an importance level of the material on the basis of the characteristic information extracted by the extracting portion; and
a processing portion that processes data of the material on the basis of the importance level determined by the determining portion.

2. The information processing system according to claim 1, further comprising an analysis portion that analyzes a content of the material on the basis of the data of the material,
wherein the determining portion determines the importance level of the material on the basis of the characteristic information extracted by the extracting portion and the content of the material analyzed by the analysis portion.

3. The information processing system according to claim 1, wherein:
when the material includes a plurality of elements, the determining portion determines the importance level for each of the plurality of elements; and
the processing portion processes the data of the elements on the basis of the importance level for each of the plurality of elements determined by the determining portion.

4. The information processing system according to claim 3, wherein the processing portion creates data obtained by composing the elements on the basis of the importance level for each of the plurality of elements determined by the determining portion.

5. The information processing system according to claim 4, wherein the processing portion composes the elements by changing regions on which the elements are allocated according to the importance level for each of the plurality of elements.

6. The information processing system according to claim 1, wherein the extracting portion extracts the information on an intention of the presenter as the characteristic information.

7. The information processing system according to claim 6, wherein the information on the intention of the presenter includes at least one of a presentation time of the material of the presenter, an attribute of the presenter, the number of presenters, the number of descriptions of the material of the presenter, a keyword mentioned by the presenter, and a movement of the presenter pointing an attention region in the material.

8. The information processing system according to claim 1, wherein the extracting portion extracts the information on a reaction of the participant as the characteristic information.

9. The information processing system according to claim 8, wherein the information on the reaction of the participant includes at least one of the number of participant's references to the material and a participant's viewing rate of the material.

10. The information processing system according to claim 2, wherein the analysis portion analyzes the content of the material on the basis of at least one of a keyword, sound data, and image data included in the data of the material.

11. The information processing system according to claim 1, wherein the determining portion classifies the material on the basis of the characteristic information extracted by the extracting portion, and determines the importance level of each of the material according to a result of a classification.

12. The information processing system according to claim 11, wherein the processing portion implements a delivery process of the data of the material on the basis of the importance level of the material determined by the determining portion.

13. The information processing system according to claim 12, wherein the processing portion selects the material to be processed on the basis of the result of the classification of the material.

14. The information processing system according to claim 1, wherein the material is at least one of an electronic material and a paper material.

15. An information processing method comprising:
extracting characteristic information of at least one of a presenter and a participant while the presenter is delivering a presentation to the participant with the use of a material, on the basis of information on at least one of the presenter and the participant captured;
determining an importance level of the material on the basis of the characteristic information extracted by the extracting portion; and
processing data of the material on the basis of the importance level determined by the determining portion.

16. The information processing method according to claim 15 further comprising: analyzing a content of the material on the basis of the data of the material,
wherein determining the importance level of the material on the basis of the characteristic information extracted and the content of the material analyzed.

17. The information processing method according to claim 15, wherein:
when the material includes a plurality of elements, determining the importance level for each of the plurality of elements; and
processing the data of the elements on the basis of the importance level for each of the plurality of elements determined.

18. A computer readable medium storing a program causing a computer to execute a process for information processing, the process comprising:
extracting characteristic information of at least one of a presenter and a participant while the presenter is delivering a presentation to the participant with the use of a material, on the basis of information on at least one of the presenter and the participant captured;
determining an importance level of the material on the basis of the characteristic information extracted by the extracting portion; and
processing data of the material on the basis of the importance level determined by the determining portion.
